(19) United States
(12) Patent Application Publication
(10) Pub. No.: US 2007/0227611 A1
(43) Pub. Date: Oct. 4, 2007

(54) Elongated Water Absorbant Barrier

(76) Inventor: Mariliyn Moffitt, Riviera Beach, FL (US)

Correspondence Address: LAW OFFICES OF JOSEPH R. CRUSE, JR., 28215 AGOURA ROAD, SUITE 130, AGOURA HILLS, CA, 91301, US

(21) Appl. No.: 11/682,138

(22) Filed: Mar. 5, 2007

Related U.S. Application Data
(60) Provisional application No. 60/779,963, filed on Mar. 6, 2006.

(51) Int. Cl. F16L 9/00

(52) U.S. Cl. 138/178

(57) ABSTRACT

A water and moisture absorbing apparatus for preventing water intrusion which comprises an elongated barrier that is capable of absorbing water and moisture along its length and reducing the risk and damage associated from water intrusion.

### FIELD OF THE INVENTION

The present invention relates to an elongated tubular shaped form that serves as a water-absorbant barrier to temporarily prevent and/or help block intrusion of water from sources such as leaking windows, doors, sinks, toilet overflows and pipes.

### OPERATION OF THE INVENTION

Homes ad businesses constantly encounter problems which deal with water damage caused by water entering from leaking windows, doors, and faulty plumbing. Unfortunately, often this occurs in inclimate weather, such as thunderstorms, tornadoes and hurricanes. The high winds of these storms cause water to be forced through the smallest of cracks in the windows and doors.

Other obvious problems occur when a sink or toilet overflows or a water pipe inside of a house breaks spilling water all over the floor causing significant damage.

Therefore, a need exists for an inexpensive, efficient and effective invention that temporarily prevents or blocks the intrusion of water.

The present invention is an elongated tubular-shaped form that serves as a water-absorbant and retentive barrier to temporarily prevent or block the intrusion of water from sources such as leaking windows, doors, sinks, toilet overflows and pipes.

The invention is placed near the source to be blocked and/or contained. The invention can be laid next to the leaking source or alternatively be secured to the area by double sided tape or similar attaching means. The material inside the invention takes up the water via an absorbant material that is retained inside layers of a fabric or paper like disposable material sealed at the ends.

The absorbant material can distend and enlarge many times its original volume as it absorbs the water. The water and moisture is contained within the outer sleeve, thereby limiting and/or preventing further intrusion.

In the preferred embodiment, the present invention is tubular in form and can be packaged in a variety of lengths to accommodate a particular location or need.

Although the preferred embodiment is in a tubular form, the invention can further be shaped in rectangular, square or triangular shapes as well.

### SUMMARY

In accordance with the present invention a device that is capable of absorbing water and moisture from water intrusion.

### DESCRIPTION

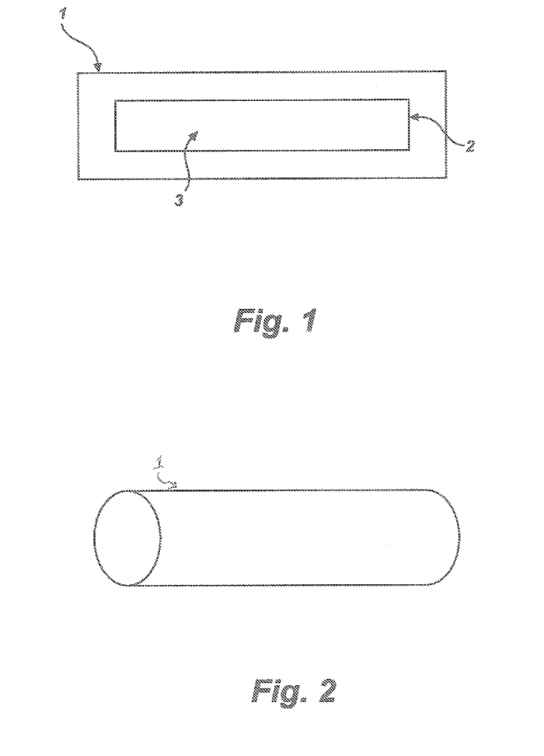

FIG. 1 shows a cross-section of the invention illustrating the absorbant portion of the invention.

FIG. 2 shows a perspective view of the invention.

### DETAILED DESCRIPTION

The following detailed description is of the best mode presently contemplated for carrying out the invention. This description is not to be taken in a limiting sense, but is made merely for the purpose of describing the general principles of the invention.

FIGS. 1 and 2 illustrate the inventive Elongated Water Absorbant Barrier (1). The Elongated Water Absorbant Barrier (1) is easy to manufacture, easy to use and disposable. As shown in FIG. 1, the barrier (1) consists of an absorbant (3) enclosed within a sleeve (2). The sleeve (2) material is a porous fiber type material, such as cellulose or an equivalent material, that may be varied to precisely determine the rigidity and absorbtion characteristics desired.

### The absorbant material (3) should be dispersed generally throughout the sleeve (2) area.

The barrier (1) can be utilized with only gravitational pressure and does not require any adhesive to be placed upon it, making manufacture less expensive. However, an adhesive, such as glue, tape, Velcro or other equivalent may be added to the barrier (1) as a means of keeping the barrier in place.

FIG. 2 displays a perspective view of the invention. The barrier (1) and the absorbant material (3) are preferred to be in generally round cross-section as displayed in FIG. 2, but may also be oval, or of other equivalent cross-section as may be desired.

What is claimed is:

1. An Elongated Water Absorbant Barrier comprising:
a tubular liquid-absorbant cover member possessing longitudally opposing ends;
a liquid-absorbent sleeve interposed within said cover member and which extends between the longitudal ends on an inner side of the cover member;
side longitudal ends of the cover member and the sleeve being closed at said respective ends;
absorbant material interposed within the sleeve and dispersed generally throughout the sleeve;
means for absorbing generally water and moisture intrusion, whereby the barrier closely conforms to the contours of a surface;
and wherein the barrier comprises a unitary, one piece construction.

2. The barrier according to claim 1, wherein the barrier possesses a means for securely attaching the barrier to a surface.
